(19) United States
(12) Patent Application Publication
(10) Pub. No.: US 2025/0184397 A1
(43) Pub. Date: Jun. 5, 2025

(54) MESSAGE TRANSMITTING APPARATUS AND MESSAGE RECEIVING APPARATUS

(71) Applicant: NTT DOCOMO, INC., Tokyo (JP)

(72) Inventor: Tomohito YAMASAKI, Chiyoda-ku (JP)

(73) Assignee: NTT DOCOMO, INC., Tokyo (JP)

(21) Appl. No.: 18/729,351

(22) PCT Filed: Dec. 7, 2022
(86) PCT No.: PCT/JP2022/045071

§ 371 Date: Feb. 7, 2025

(30) Foreign Application Priority Data
Jan. 28, 2022 (JP) 2022-011593

(51) Int. Cl. H04L 67/131; G06F 3/04815; G06F 3/04845; G06T 19/00

(52) U.S. Cl. CPC H04L 67/131; G06F 3/04815; G06F 3/04845; G06T 19/00

(57) ABSTRACT

A terminal apparatus includes a movement track information generator configured to, when a virtual object corresponding to a message is moved in a virtual space in accordance with an operation by a user who is a sender, generate movement track information on a movement track of the virtual object; a transmission information generator configured to generate transmission information including the movement track information and message information indicative of the message; and a transmission controller configured to cause a communication device to transmit the transmission information to a recipient specified by the user.

### TECHNICAL FIELD

The present invention relates to a message transmitting apparatus for transmitting messages and to a message receiving apparatus for receiving messages.

### BACKGROUND ART

Non-Patent Document 1 discloses an animation of a character delivering an email, the animation being displayed upon transmission of an email and upon receipt of an email. In this technique, when a user transmits an email, an animation of an animal character holding an email and leaving a room is displayed on a display. When the user receives an email, an animation of a character holding an email and approaching is displayed on the display.

In XR techniques including a virtual reality (VR) technique, an augmented reality (AR) technique, and a mixed reality (MR) technique, a three-dimensional virtual space is displayed by a pair of XR glasses worn on a user's head. In this virtual space, a virtual object corresponding to a message may appear. When the technique described in Non-Patent Document 1 is applied to the three-dimensional virtual space, an animation of a character delivering a virtual object will be displayed by the pair of XR glasses.

### RELATED ART DOCUMENT

### Non-Patent Document

Non-Patent Document 1: “Let's play with Postpet, the currently popular email software!”, [online], Oct. 13, 1997, watch editing section. INTERNET [Search on Jan. 24, 2022], Internet <URL:https://intcrnct.watch.impress.co.jp/www/article/971013/special.htm>

### SUMMARY OF THE INVENTION

### Problem to be Solved by the Invention

However, movement of the character delivering the virtual object is a predetermined action. Thus, a user who is a sender cannot control movement of the virtual object in the virtual space visually recognized by a user who is a recipient.

An object of this disclosure is to provide a message transmitting apparatus and a message receiving apparatus that enable a user who is a sender of a message to control movement of a virtual object in a virtual space visually recognized by a user who is a recipient of the message.

### Means for Solving Problem

A message transmitting apparatus according to a preferred aspect of the present invention includes a movement track information generator configured to, when a virtual object corresponding to a message is moved in a virtual space in accordance with an operation by a user who is a sender, generate movement track information on a movement track of the virtual object; a transmission information generator configured to generate transmission information including the movement track information; and message information indicative of the message; and a transmission controller configured to cause a communication device to transmit the transmission information to a recipient specified by the user.

A message receiving apparatus according to a preferred aspect of the present invention includes a reception controller configured to cause a communication device to receive the transmission information transmitted by the message transmitting apparatus; an imagery generator configured to generate imagery in which a virtual object moves in a virtual space in accordance with the movement track information included in the transmission information; and a display controller configured to cause a display for a user who is the recipient to display the generated imagery.

### Effect of Invention

According to the present invention, a user who is a sender can control movement of a virtual object in a virtual space visually recognized by a user who is a recipient.

### BRIEF DESCRIPTION OF THE DRAWINGS

FIG. 1 is a diagram showing an overall configuration of an information processing system 1 according to an embodiment.

FIG. 2 is a schematic diagram showing an example of a virtual space VS visually recognized by a user U[K], who is a sender, through a pair of XR glasses 20-K.

FIG. 3 is a perspective view showing an appearance of the pair of XR glasses 20-K according to this embodiment.

FIG. 4 is a block diagram showing an example of a configuration of the pair of XR glasses 20-K according to this embodiment.

FIG. 5 is a block diagram showing an example of a configuration of a terminal apparatus 10-K according to this embodiment.

FIG. 6 is an explanatory diagram showing an example of an information structure of reference movement track information D.

FIG. 7 is a schematic diagram showing a first reference movement track Sr1 to a seventh reference movement track Sr7.

FIG. 8 is a functional block diagram showing a movement track information generator 113.

FIG. 9 is an explanatory diagram showing an example of a user movement track Su1 that is to be modified and an example of a modified user movement track Su2.

FIG. 10A is a schematic diagram showing an example of a movement track Sx obtained by combining a movement track S with the first reference movement track Sr1.

FIG. 101B is a schematic diagram showing an example of a movement track Sy obtained by combining the first reference movement track Sr1 with a third reference movement track Sr3.

FIG. 11 is a schematic diagram showing an example of the virtual space VS at a point in time at which the user U[K] selects one or more movement tracks from among a plurality of movement tracks.

FIG. 12 is a block diagram showing an example of a configuration of a server 30.

FIG. 13 is a flowchart showing an example of a transmission processing procedure executed by the terminal apparatus 10-K according to this embodiment.

FIG. 14A is a schematic diagram showing an example of an association between message information and a virtual object VO.

FIG. 14B is a schematic diagram showing an example of the virtual space VS for generation of a movement track of the virtual object VO.

FIG. 15 is a flowchart showing an example of a processing procedure to generate movement track information.

FIG. 16A is a schematic diagram showing an example of the virtual space VS for receiving input of a user movement track.

FIG. 16B is a schematic diagram showing an example of the virtual space VS for receiving input of an instruction to combine movement tracks.

FIG. 17 is a flowchart showing an example of a transmission processing procedure executed by the terminal apparatus 10-K according to this embodiment.

### MODES FOR CARRYING OUT THE INVENTION

### 1: Embodiment

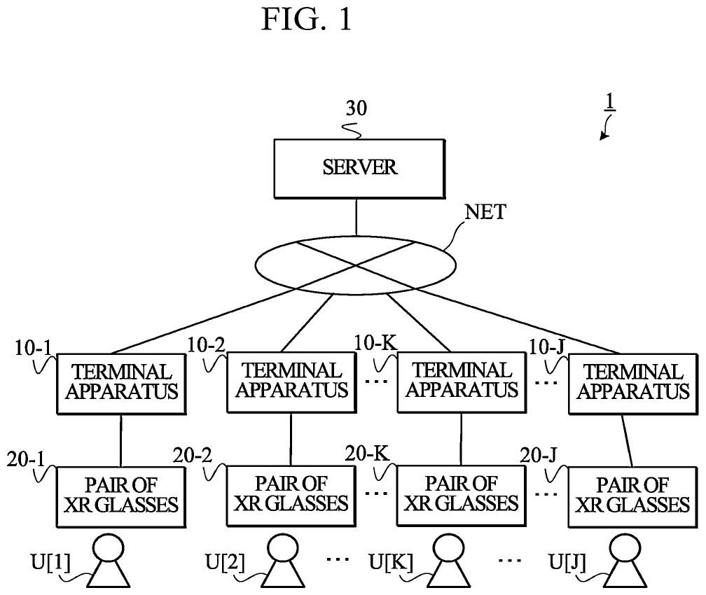

With reference to FIG. 1 to FIG. 17, an information processing system 1 will be described.

### 1. 1: Configuration of Embodiment

### 1. 1. 1: Overall Configuration

FIG. 1 is a block diagram showing an overall configuration of the information processing system 1. As shown in FIG. 1, the information processing system 1 includes terminal apparatuses 10-1, 10-2 . . . 10-K . . . 10-J, pairs of XR glasses 20-1, 20-2 . . . 20-K . . . 20-J. and a server 30. J is an integer greater than or equal to 1. K is an integer greater than or equal to 1 and less than or equal to J. In this embodiment, the terminal apparatuses 10-1, 10-2 . . . 10-K . . . 10-J have the same configuration. However, a terminal apparatus may be included that has a configuration that is not the same as that of another terminal apparatus. In this embodiment, the pairs of XR glasses 20-1, 20-2 . . . 20-K . . . 20-J have the same configuration. However, a pair of XR glasses may be included that has a configuration that is not the same as that of another pair of XR glasses.

In the information processing system 1, the terminal apparatus 10-K and the server 30 are connected to, and are communicable with, each other via a communication network NET. The terminal apparatus 10-K and the pair of XR glasses 20-K are connected to, and are communicable with, each other. In FIG. 1, a user U[K] uses a combination of the terminal apparatus 10-K and the pair of XR glasses 20-K. Similarly, users U[1], U[2] . . . U[K−1], U[K+1] . . . U[J] each use a combination of a terminal apparatus and a pair of XR glasses. The terminal apparatus 10-K is an example of a message transmitting apparatus and is an example of a message receiving apparatus.

The server 30 provides the terminal apparatus 10-K with various types of data and cloud services via the communication network NET. The cloud services include a service for transmitting messages and a service for receiving messages.

The terminal apparatus 10-K causes the pair of XR glasses 20-K worn on the head of the user U[K] to display a virtual object disposed in a virtual space. The virtual space is a three-dimensional space. The virtual object is represented in three dimensions. The virtual object is, for example, a virtual object indicative of data such as a still image, a video, a 3DCG model, a HTML file, and a text file, and may be a virtual object indicative of an application. The text file indicates notes, source codes, diaries, and recipes, for example. The application is, for example, a web browser, an application for using an SNS, or an application for generating document files. The terminal apparatus 10-K is preferably a mobile terminal apparatus such as a smart phone and a tablet.

The pair of XR glasses 20-K is a see-through type of wearable display for being worn on the head of the user U[K]. The pair of XR glasses 20-K displays, based on control of the terminal apparatus 10-K, the virtual object on a display panel provided in each lens of a pair of lenses for both eyes. The pair of XR glasses 20-K is an example of a display.

In this embodiment, the user U[K] wearing the pair of XR glasses 20-K on the head uses the terminal apparatus 10-K to transmit message information indicative of a message to the terminal apparatus 10-1 used by the user U[1] who is another user, for example. The message may be a text message, a voice message, or a video message such as an animation, for example.

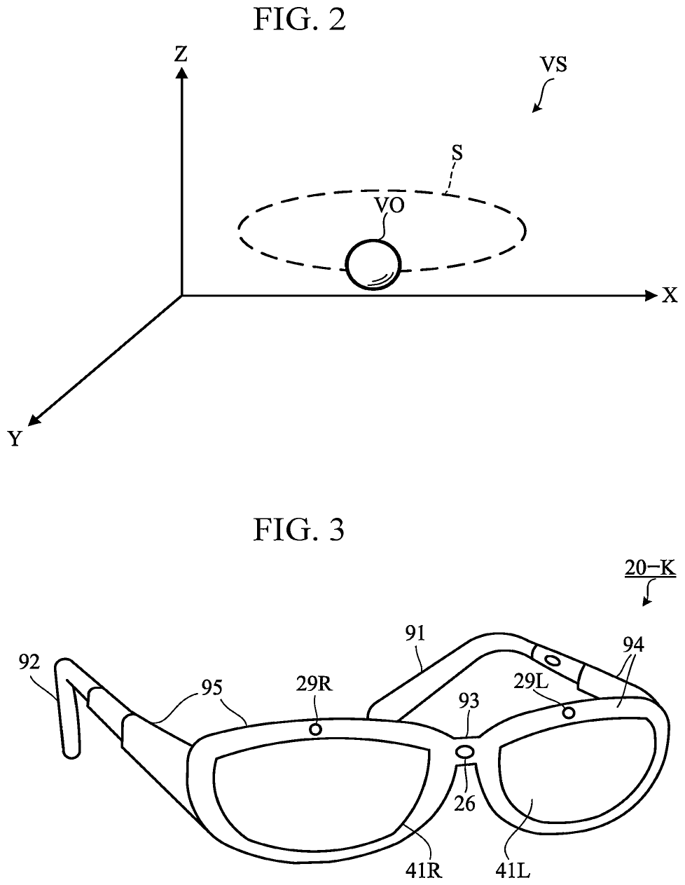

FIG. 2 is a diagram showing an example of a virtual space VS visually recognized by the user U[K], which is a sender, through the pair of XR glasses 20-K. In FIG. 2, an X-axis, a Y-axis, and a Z-axis are perpendicular to one another. In the following description, a positive direction along the X-axis is referred to as a positive X direction, a negative direction along the X-axis is referred to as a negative X direction, a positive direction along the Y-axis is referred to as a positive Y direction, a negative direction along the Y-axis is referred to as a negative Y direction, a positive direction along the Z-axis is referred to as a positive Z direction, and a negative direction along the Z-axis is referred to as a negative Z direction. In the virtual space VS shown in FIG. 2, them is a virtual object VO corresponding to the message from the user U[K]. The user U[K] can transmit the message information by specifying a recipient. In this example, the virtual object VO has a spherical shape. The virtual object VO is moved in the virtual space VS in accordance with an operation by the user U[K]. The virtual object VO shown in FIG. 2 is moved along a movement track S. For example, the user U[K] holds the virtual object VO in one hand and moves the virtual object VO such that the virtual object VO is moved around a body of the user U[K] for one round. In FIG. 2, the user U[K] is omitted.

In this embodiment, movement track information on the movement track S of the virtual object VO that was moved by the user who is the sender in the virtual space VS, together with the message information in association with the movement track information, is transmitted to the user U[1] who is the recipient. When the user U[1] visually recognizes the virtual space VS through the pair of XR glasses 20-1, the virtual object VO moves in the virtual space VS based on the movement track information. According to the information processing system 1, the user U[K] who is the sender can control movement of the virtual object VO in the virtual space visually recognized by the user U[1] who is the recipient. The user U[1] is an example of a user who is a recipient.

### 1. 1. 2: Configuration of Pair of XR Glasses

FIG. 3 is a perspective view showing an appearance of the pair of XR glasses 20-K. As shown in FIG. 2, the pair of XR glasses 20-K, as well as a typical pair of glasses, has temples 91 and 92, a bridge 93, frames 94 and 95, and lenses 41L and 41R.

The bridge 93 is provided with a capturing device 26. The capturing device 26 captures the outside world. The capturing device 26 outputs captured image information indicative of a captured image. The frame 94 is provided with a left-hand depth detector 29L. The frame 95 is provided with a right-hand depth detector 29R. The depth detector 29L and the depth detector 29R each output depth information indicative of a distance to an object that is present in a real space.

Each of the lenses 41L and 41R includes a one-way mirror. The frame 94 is provided with either a liquid crystal panel for left eye or an organic EL panel for left eye, and with an optical member for guiding light beams, which are emitted by a display panel for left eye, to the lens 41L. The liquid crystal panel or the organic EL panel is collectively referred to as a display panel. Light beams from the outside world pass through the one-way mirror provided in the lens 411 to be directed to the left eye of the user, and the light beams guided by the optical member to the lens 41L are reflected by the one-way mirror to be directed to the left eye of the user. The frame 95 is provided with a display panel for the right eye and with an optical member for guiding light beams, which are emitted by the display panel, to the lens 41R. Light beams from the outside world pass through the one-way mirror provided in the lens 41R to be directed to the right eye of the user, and the light beams guided by the optical member to the lens 41R are reflected by the one-way mirror to be directed to the right eye of the user.

The display 28 described below includes the lens 41L, the display panel for the left eye, the optical member for the left eye, the lens 41R, the display panel for the right eye, and the optical member for the right eye.

According to the configuration described above, the user U[K] can watch images displayed by the display panel in a transparent state in which the images are superimposed on images of the outside world. The pair of XR glasses 20-K causes the display panel for the left eye to display a left-eye image of stereo-pair images and causes the display panel for the right eye to display a right-eye image of the stereo-pair images. Thus, the pair of XR glasses 20-K causes the user U[K] to feel as if the displayed images have depth and a stereoscopic effect.

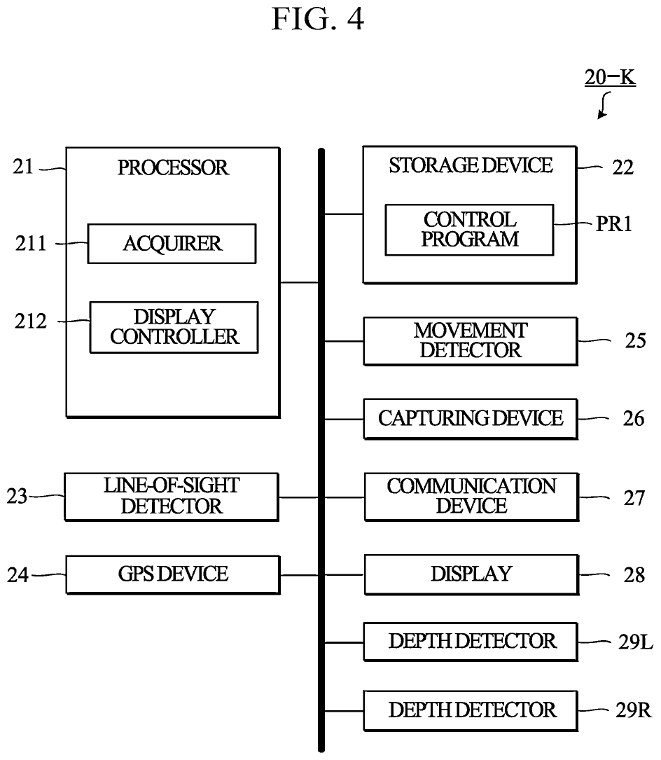

FIG. 4 is a block diagram showing an example of a configuration of the pair of XR glasses 20-K. The pair of XR glasses 20-K includes a processor 21, a storage device 22, a line-of-sight detector 23, a GPS device 24, a movement detector 25, the capturing device 26, a communication device 27, the display 28, and the depth detectors 29L and 29R. Each element of the pair of XR glasses 20-K is interconnected by a single bus or by multiple buses for communicating information. The term “device” in this specification may be understood as equivalent to another term such as circuit, device, unit, etc.

The processor 21 is a processor configured to control the entire pair of XR glasses 20-K. The processor 21 is constituted of a single chip or of multiple chips, for example. The processor 21 is constituted of a central processing unit (CPU) that includes, for example, interfaces for peripheral devices, arithmetic units, registers, etc. One, some, or all of the functions of the processor 21 may be implemented by hardware such as a digital signal processor (DSP), an application specific integrated circuit (ASIC), a programmable logic device (PLD), or a field programmable gate array (FPGA). The processor 21 executes various processing in parallel or sequentially.

The storage device 22 is a recording medium readable and writable by the processor 21. The storage device 22 stores a plurality of programs including a control program PR1 to be executed by the processor 21.

The line-of-sight detector 23 detects a line of sight of the user U[K] to generate line-of-sight information indicative of a detection result. A method for detecting the line-of-sight, which is executed by the line-of-sight detector 23, may be freely selected. For example, the line-of-sight detector 23 may generate the line-of-sight information based on a location of an inner corner of an eye and a location of an iris. The line-of-sight information indicates a direction of the line-of-sight of the user U[K]. The line-of-sight detector 23 provides the line-of-sight information to the processor 21. The line-of-sight information provided to the processor 21 is provided to the terminal apparatus 10-K via the communication device 27.

The GPS device 24 receives radio waves from a plurality of satellites. The GPS device 24 generates user location information indicative of a location of the user U[K] from the received radio waves. The user location information may be in any form as long as the location of the user U[K] can be specified. The user location information indicates a latitude and longitude of the pair of XR glasses 20-K, for example. The user location information is provided to the processor 21. The processor 21 provides the user location information to the terminal apparatus 10-K via the communication device 27.

The movement detector 25 detects movement of the pair of XR glasses 20-K. The movement detector 25 includes an inertial sensor such as an acceleration sensor for detecting acceleration and a gyro sensor for detecting angular acceleration. The acceleration sensor detects acceleration in a direction along an axis that is each of the X-axis, the Y-axis, and the Z-axis that are perpendicular to one another. The gyro sensor detects angular acceleration of rotation having a rotation axis that is each of the X-axis, the Y-axis, and the Z-axis. The movement detector 25 can generate user orientation information indicative of an orientation of the pair of XR glasses 20-K based on output information from the gyro sensor. User movement information includes acceleration information indicative of acceleration for each of the three axes and angular acceleration information indicative of angular acceleration for each of the three axes. The movement detector 25 provides the processor 21 with the user orientation information indicative of the orientation of the pair of XR glasses 20-K and the user movement information on movement of the pair of XR glasses 20-K. The user orientation information and the user movement information provided to the processor 21 are provided to the terminal apparatus 10-K via the communication device 27.

The capturing device 26 outputs the captured image information obtained by capturing the outside world. The capturing device 26 includes lenses, a capturing element, an amplifier, and an AD converter, for example. Light beams focused through the lenses are converted by the capturing element into a captured image signal, which is an analog signal. The amplifier amplifies the captured image signal and provides the amplified captured image signal to the AD converter. The AD converter converts the amplified captured image signal, which is an analog signal, into the captured image information, which is a digital signal. The captured image information, which has been made through the conversion, is provided to the processor 21. The captured image information provided to the processor 21 is provided to the terminal apparatus 10-K via the communication device 27. The capturing device 26 is, for example, a camera.

The communication device 27 is hardware that is a transmitting and receiving device configured to communicate with other devices. For example, the communication device 27 may be referred to as a network device, a network controller, a network card, a communication module, etc. The communication device 27 may include a connector for wired connection and an interface circuit corresponding to the connector for wired connection. The communication device 27 may include a wireless communication interface. The connector for wired connection and the interface circuit may conform to wired LAN, IEEE1394, or USB. The wireless communication interface may conform to wireless LAN or Bluetooth (registered trademark), etc.

The display 28 is a device for displaying images. The display 28 displays various types of images under control of the processor 21. The display 28 includes the lens 41L, the display panel for the left eye, the optical member for the left eye, the lens 41R, the display panel for the right eye, and the optical member for the right eye, as described above. As the display panel, a type of display panel such as a liquid crystal display panel or an organic EL display panel is preferably used, for example.

### 1. 1. 3: Configuration of Terminal Apparatus

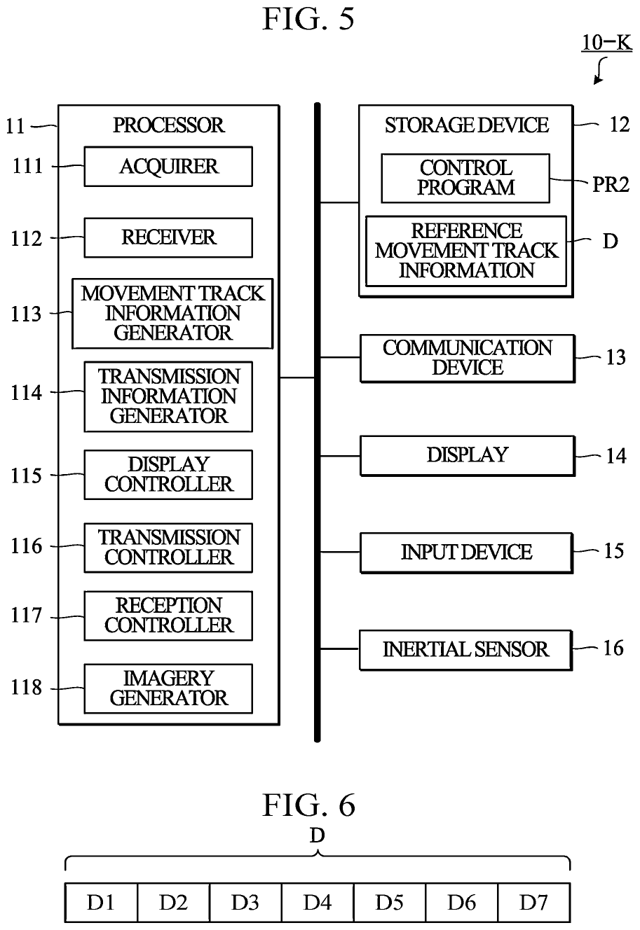

FIG. 5 is a block diagram showing an example of a configuration of the terminal apparatus 10-K. The terminal apparatus 10-K includes a processor 11, a storage device 12, a communication device 13, a display 14, an input device 15, and an inertial sensor 16. Each element of the terminal apparatus 10-K is interconnected by a single bus or by multiple buses for communicating information.

The processor 11 is a processor configured to control the entire terminal apparatus 10-K. The processor 11 is constituted of a single chip or of multiple chips, for example. The processor 11 is constituted of a central processing unit (CPU) that includes, for example, interfaces for peripheral devices, arithmetic units, registers, etc. One, some, or all of the functions of the processor 11 may be implemented by hardware such as a DSP, an ASIC, a PLD, or an FPGA. The processor 11 executes various processing in parallel or sequentially.

The storage device 12 is a recording medium readable and writable by the processor 11. The storage device 12 stores a plurality of programs including a control program PR2 to be executed by the processor 11. The storage device 12 may further store external image information indicative of an image to be displayed on the pair of XR glasses 20-K. This external image information includes external image information indicative of the virtual object VO corresponding to the message.

The storage device 12 further stores reference movement track information D. The reference movement track information D indicates a plurality of movement tracks of the virtual object VO specified in advance. As described with reference to FIG. 2, the user U[K] can move the virtual object VO in the virtual space VS by directly operating the virtual object VO. The user 1[K] can also select a movement track from among the plurality of movement tracks specified in advance. In this case, the virtual object VO moves along the selected movement track. As shown in FIG. 6, the reference movement track information D includes first reference movement track information D1 indicative of a first reference movement track Sr1, second reference movement track information D2 indicative of a second reference movement track Sr2, third reference movement track information D3 indicative of a third reference movement track Sr3, fourth reference movement track information D4 indicative of a fourth reference movement track Sr4, fifth reference movement track information D5 indicative of a fifth reference movement truck Sr5, sixth reference movement track information D6 indicative of a sixth reference movement track Sr6, and seventh reference movement track information D7 indicative of a seventh reference movement track Sr7.

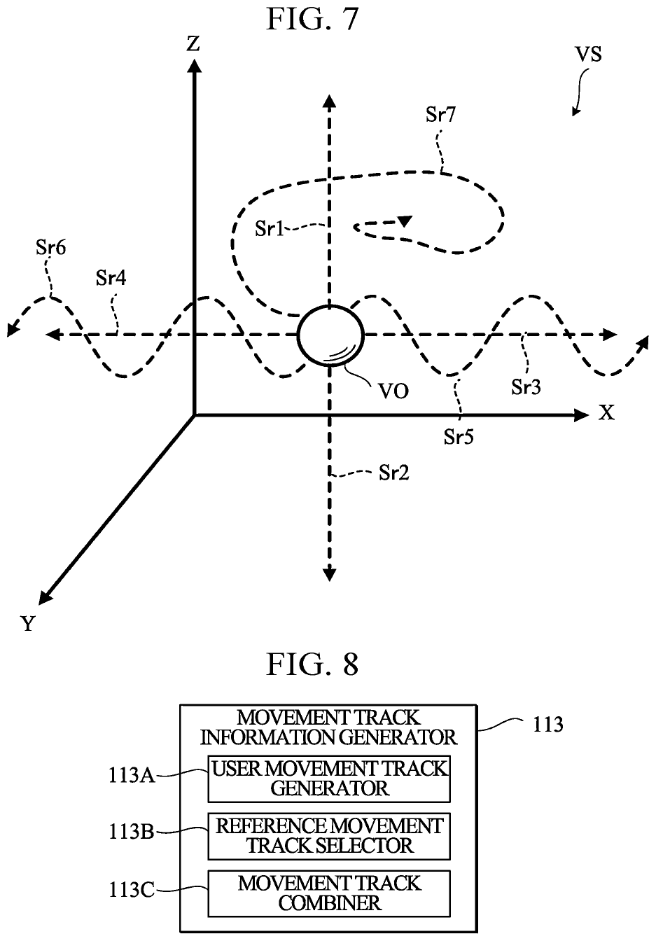

FIG. 7 is a schematic diagram showing the first reference movement track Sr1 to the seventh reference movement track Sr7. The first reference movement track Sr1 is a movement track for movement of the virtual object VO in the positive Z direction, in other words, in an upward direction in the drawing. The second reference movement track Sr2 is a movement track for movement of the virtual object VO in the negative Z direction, in other words, in a downward direction in the drawing. The third reference movement track Sr3 is a movement track for movement of the virtual object VO in the positive X direction, in other words, in a rightward direction in the drawing. The fourth reference movement track Sr4 is a movement track for movement of the virtual object VO in the negative X direction, in other words, in a leftward direction in the drawing. The fifth reference movement track Sr5 is a movement track for movement of the virtual object VO in a wave-like manner in the positive X direction. The sixth reference movement track Sr6 is a movement track for movement of the virtual object VO in a wave-like manner in the negative X direction. The seventh reference movement track Sr7 is a movement track for movement in which the virtual object VO drifts in the virtual space VS.

The communication device 13 shown in FIG. 5 is hardware that is a transmitting and receiving device configured to communicate with other devices. For example, the communication device 13 may be referred to as a network device, a network controller, a network card, a communication module, etc. The communication device 13 may include a connector for wired connection and an interface circuit corresponding to the connector for wired connection. The communication device 13 may include a wireless communication interface. The connector for wired connection and the interface circuit may conform to wired LAN, IEEE1394, or USB. The wireless communication interface may conform to wireless LAN or Bluetooth (registered trademark), etc.

The display 14 is a device for displaying images and text information. The display 14 displays various types of images under control of the processor 11. As the display 14, a type of display panel such as a liquid crystal display panel and an organic electroluminescent (EL) display panel is preferably used, for example.

The input device 15 generates operation information in accordance with an operation of the input device 15 by the user U[K]. The input device 15 provides the operation information to the processor 11. For example, the input device 15 includes a pointing device such as a keyboard, a touch pad, a touch panel, or a mouse. In a case in which the input device 15 includes a touch panel, the input device 15 may also serve as the display 14.

The inertial sensor 16 is a sensor for detecting inertial force. The inertial sensor 16 includes one or more sensors among an acceleration sensor, an angular velocity sensor, and a gyro sensor, for example. The inertial sensor 16 provides sensor information indicative of detection results of the one or more sensors to the processor 11. The processor 11 detects an orientation of the terminal apparatus 10-K based on the sensor information. The processor 11 further receives selection of the virtual object VO, input of text, and input of instructions, in the virtual space VS based on the orientation of the terminal apparatus 10-K. For example, when the user U[K] causes a central axis of the terminal apparatus 10-K to face a predetermined region in the virtual space VS and operates the input device 15, the virtual object VO disposed in the predetermined region is selected. The operation of the input device 15 by the user U[K] is, for example, a double tap. Thus, if the user U[K] operates the terminal apparatus 10-K as described above, the user U[K] can select the virtual object VO without looking at the input device 15 of the terminal apparatus 10-K. The processor 11 displays a virtual keyboard, which has a plurality of virtual keys for input of text, in the virtual space. When the user U[K] causes the central axis of the terminal apparatus 10-K to face a virtual key and operates the input device 15, text is input. The user U[K] can enter an address of the recipient of the message by performing such an input operation.

The processor 11 reads the control program PR2 from the storage device 12 and executes the read control program PR2. As a result, the processor 11 functions as an acquirer 111, a receiver 112, a movement track information generator 113, a transmission information generator 114, a display controller 115, a transmission controller 116, and a reception controller 117.

The acquirer 111 acquires information, which includes the captured image information, the line-of-sight information, the user location information, the user orientation information, the user movement information, and the depth information, via the communication device 13.

The receiver 112 receives the operation information output from the input device 15 and the sensor information output from the inertial sensor 16. The receiver 112 generates device orientation information indicative of the orientation of the terminal apparatus 10-K based on the sensor information.

When the virtual object VO corresponding to the message is moved in the virtual space in accordance with the operation by the user U[K], the movement track information generator 113 generates the movement track information on the movement track of the virtual object VO. The user U[K] is the user who is the sender of the message. The operation by the user U[K] includes an operation based on the line of sight of the user U[K] and a gesture of the user U[K] in addition to the operation of the input device IS. The operation based on the line-of-sight is specified by the line-of-sight information acquired from the pair of XR glasses 20-K. The operation based on the gesture is specified by the captured image information acquired from the pair of XR glasses 20-K.

FIG. 8 is a block diagram showing a detailed configuration of the movement track information generator 113. The movement track information generator 113 includes a user movement track generator 113A, a reference movement track selector 113B, and a movement track combiner 113C.

The user movement track generator 113A generates, as the user movement track, a movement track of the virtual object VO moved by the user U[K] directly performing operation of the virtual object VO corresponding to the message. The directly operation of the virtual object VO by the user U[K] is an example of a second operation. For example, the operation of the virtual object VO by the user U[K] is an operation in which the user U[K] holds the virtual object VO in one hand and moves the virtual object VO in the virtual space VS. When this operation is performed, the user movement track generator 113A determines the movement track of the virtual object VO by tracking locations of the hand of the user U[K]. The user movement track generator 113A determines the locations of the hand of the user U[K] based on the depth information. Alternatively, the user movement track generator 113A determines the locations of the hand of the user U[K] based on the captured image information. To determine the locations of the hand based on the captured image information, the user movement track generator 113A may determine the locations of the hand using a trained model that is trained to learn a relationship between a captured image and a location of a hand.

The user movement track generator 113A generates path information indicative of a change in a location of the hand of the user U[K] over time. Relative location information is known that indicates a relative locational relationship between a location of the hand of the user U[K] and a location of the center of the virtual object VO. The user movement track generator 113A calculates the user movement track, which represents a change in a location of the virtual object VO in the virtual space VS over time, based on the path information and on the relative location information to generate the user movement track information indicative of the calculated user movement track. The movement track S shown in FIG. 2 is an example of a user movement track.

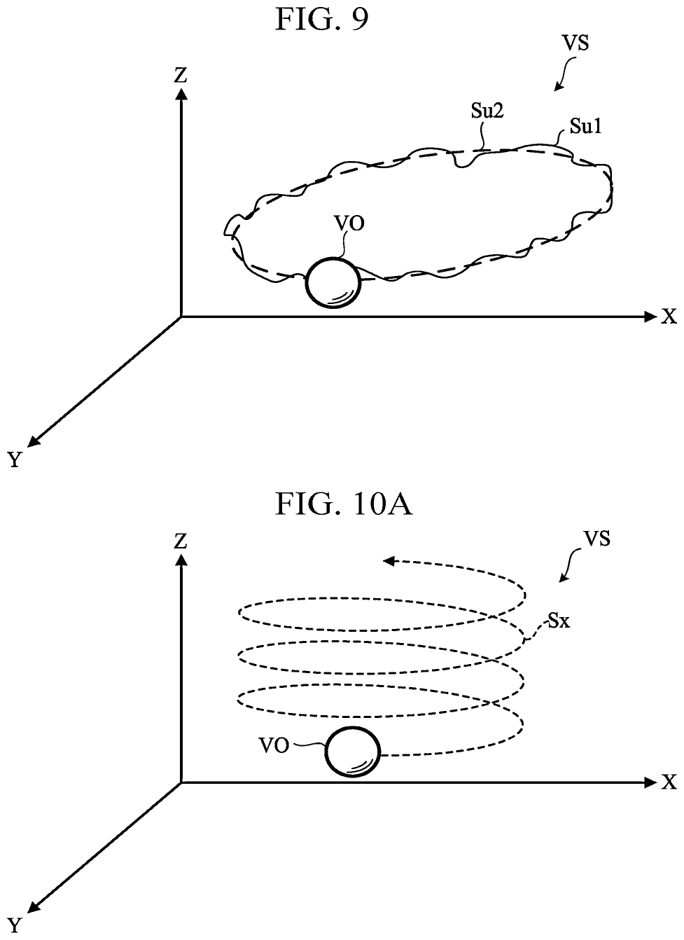

When the user U[K] directly operates the virtual object VO, the hand of the user U[K] may shift a little. In this case, the user movement track is a just a little shifting movement track. Thus, the user movement track generator 113A may modify the user movement track by executing processing on the user movement track, the processing being processing to remove a noise component caused by the operation by the user U[K]. When this modification is executed, the user movement track information generated by the user movement track generator 113A indicates a modified user movement track. For example, a user movement track Su1 shown in FIG. 9 is a movement track for being modified. The user movement track generator 113A generates a modified user movement track Su2 by executing the processing to remove a noise component on the user movement track Su1. The processing to remove a noise component is, for example, low-pass filtering to remove high frequency components from the user movement track. However, the processing to remove a noise component is not limited to the low-pass filtering, and it may be freely selected processing as long as it can remove noise.

The user U[K] may specify the user movement track as the movement track of the virtual object VO by directly operating the virtual object VO or may specify the movement track of the virtual object VO by selecting a movement track from among a plurality of movement tracks prepared in advance. In this embodiment, the plurality of movement tracks prepared in advance includes the first reference movement track Sr1, the second reference movement track Sr2 . . . the seventh reference movement track Sr7 that are shown in FIG. 7. The movement track information generator 113 may generate a combined movement track by combining the user movement track with selected one or more movement tracks and generates the movement track information indicative of the combined movement track. The combination of movement tracks may be a combination of two or more reference movement tracks or may be a combination of the user movement track and one or more reference movement tracks. An operation of selecting one or more movement tracks from among the plurality of movement tracks prepared in advance is an example of a first operation.

When the operation by the user U[K] is the first operation, the reference movement track selector 1138 determines one or more movement tracks selected by the first operation. Specifically, the reference movement track selector 113B reads reference movement track information D corresponding to the one or more movement tracks selected by the first operation from the storage device 12.

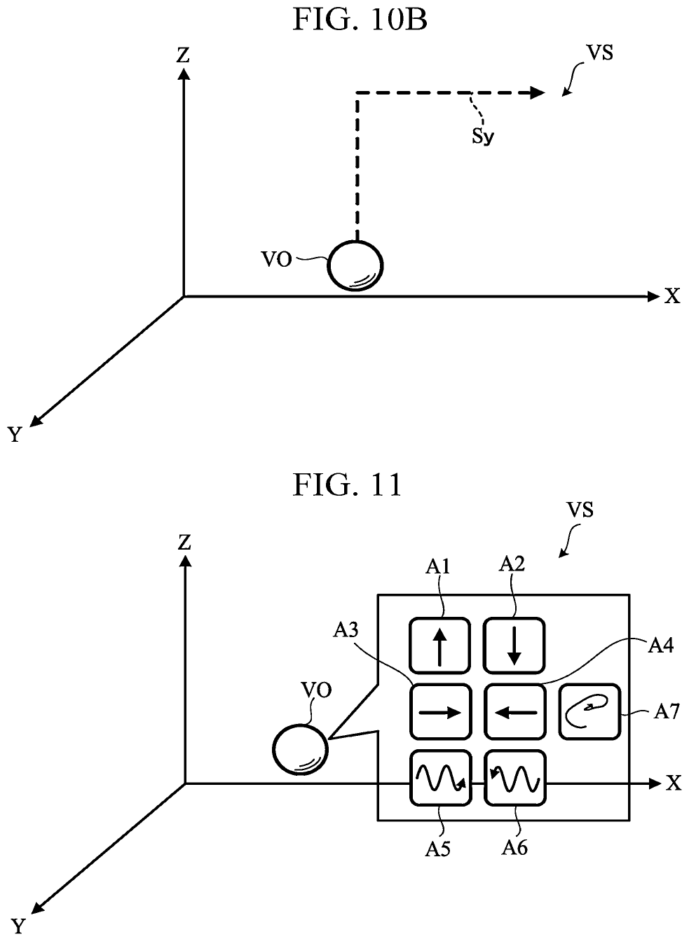

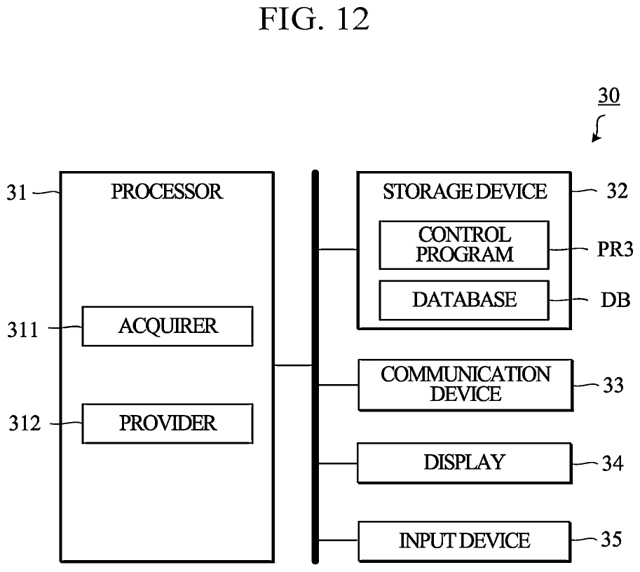

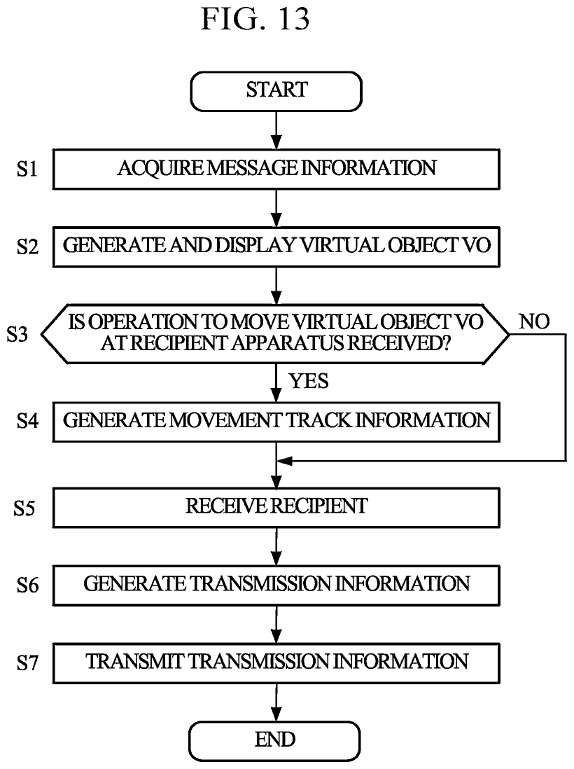

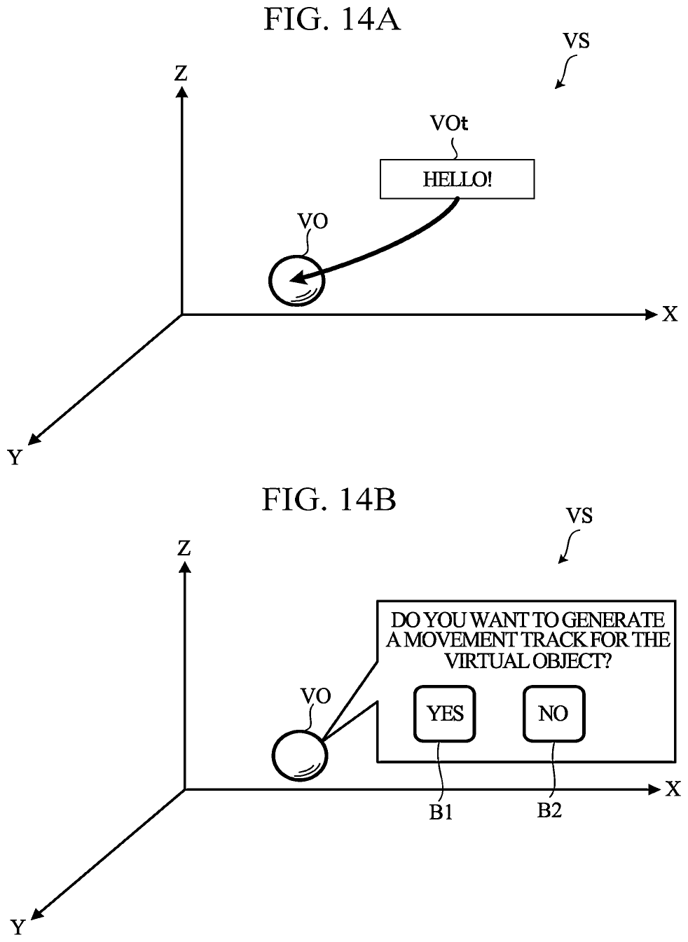

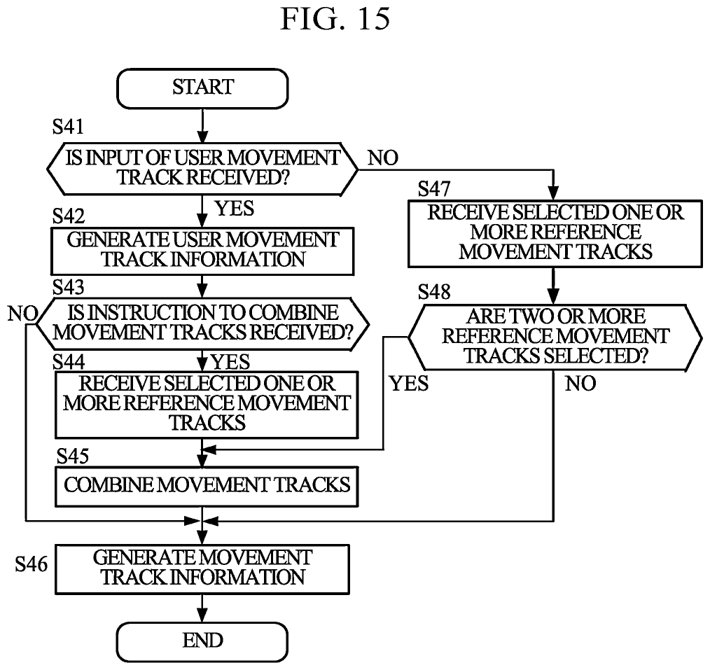

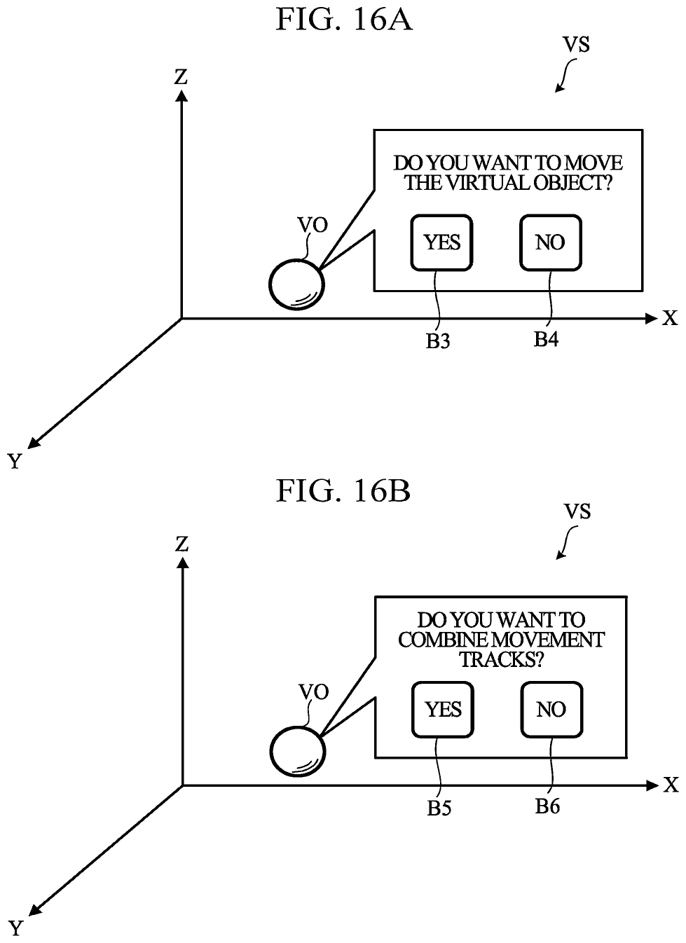

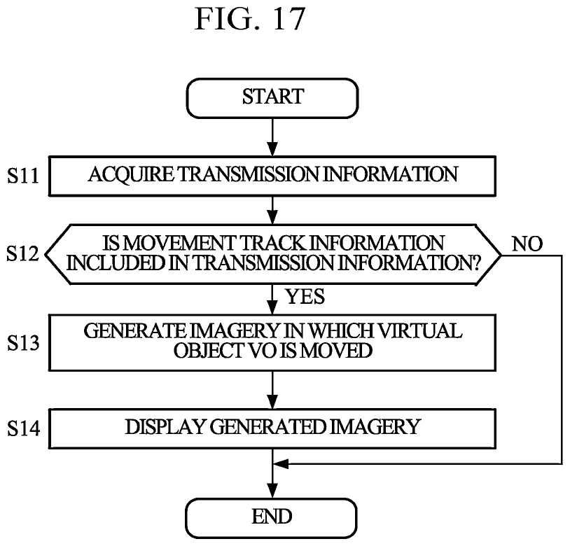

The movement track combiner 113C combines two or more movement tracks to generate the combined movement track. When the user U[K] performs the second operation to move the virtual object VO in the virtual space VS, the user movement track is generated. If the one or more movement tracks are selected by the reference movement track selector 113B in a state in which the user movement track is generated, the movement track combiner 113C combines the user movement track with the selected one or more movement tracks. For example, when the user movement track is the looped movement track S shown in FIG. 2 and a selected movement track is the first reference movement track Sr1 shown in FIG. 7, the movement track combiner 113C generates a movement track Sx shown in FIG. 10A by combining the movement track S with the first reference movement track Sr1.

When the one or more movement tracks are selected by the reference movement track selector 113B in a state in which no user movement track is generated, the movement track combiner 113C combines the one or more movement tracks. For example, when the reference movement track selector 113B selects the first reference movement track Sr1 shown in FIG. 7 and then selects the third reference movement track Sr3, the movement track combiner 113C generates a movement track Sy shown in FIG. 10B by combining the first reference movement track Sr1 with the third reference movement track Sr3.

Next, the transmission information generator 114 shown in FIG. 5 generates transmission information that includes the message information, the movement track information generated by the movement track information generator 113, recipient information, and sender information. The recipient information is, for example, an address indicative of the recipient of the message. The sender information is, for example, an address indicative of the sender of the message.

The display controller 115 generates internal image information indicative of an image for being displayed on the display 14 and the external image information indicative of the image for being displayed on the pair of XR glasses 20-K. The display controller 115 provides the internal image information to the display 14. The display controller 115 provides the external image information to the pair of XR glasses 20-K via the communication device 13 to cause the pair of XR glasses 20-K to display the virtual space VS including the virtual object VO.

For example, the display controller 115 generates an image of the virtual space VS shown in FIG. 11 such that the user U[K] can select one or more movement tracks from among the plurality of movement tracks. As shown in FIG. 11, the virtual space VS is provided with a first icon A1, a second icon A2 . . . a seventh icon A7 in association with the virtual object VO. The first icon A1, the second icon A2 . . . the seventh icon A7 are in one-to one correspondence with the first reference movement track Sr1, the second reference movement track Sr2 . . . the seventh reference movement track Sr7. The user U[K] can specify one or more reference movement tracks by selecting one or more icons.

The transmission controller 116 shown in FIG. 5 causes the communication device 13 to transmit the transmission information to the recipient designated by the user U[K]. Specifically, the transmission information including the recipient information is transmitted to the server 30.

The reception controller 117 causes the communication device 13 to receive transmission information, which is transmitted by a terminal apparatus for a user who is a sender, via the server 30. When the user U[1] is a user who is a sender and the user U[K] is a user who is a recipient, transmission information transmitted by the terminal apparatus 10-1 is received by the terminal apparatus 10-K via the server 30.

The imagery generator 118 generates the virtual object VO corresponding to the message. The imagery generator 118 generates imagery in which the virtual object VO moves in the virtual space VS in accordance with the movement track information included in the received transmission information. The imagery generator 118 provides external image information indicative of the generated imagery to the display controller 115. The display controller 115 provides the external image information to the pair of XR glasses 20-K for the user U[K], which is a user who is a recipient. When the user U[1] is a user who is a sender, movement of the virtual object VO that is moved in the virtual space VS in accordance with an operation by the user U[1] is displayed on the pair of XR glasses 20-K for the user U[K] who is a recipient. This display allows the user U[K] to visually recognize the virtual object VO moving in the virtual space VS through the pair of XR glasses 20-K.

### 1. 1. 4: Configuration of Server

FIG. 12 is a block diagram showing an example of a configuration of the server 30. The server 30 includes a processor 31, a storage device 32, a communication device 33, a display 34, and an input device 35. Each element of the server 30 is interconnected by a single bus or by multiple buses for communicating information.

The processor 31 is a processor configured to control the entire server 30. The processor 31 is constituted of a single chip or of multiple chips, for example. The processor 31 is constituted of a central processing unit (CPU) that includes, for example, interfaces for peripheral devices, arithmetic units, registers, etc. One, some, or all of the functions of the processor 31 may be implemented by hardware such as a DSP, an ASIC, a PLD, or an FPGA. The processor 31 executes various processing in parallel or sequentially.

The storage device 32 is a recording medium readable and writable by the processor 31. The storage device 32 stores a plurality of programs including a control program PR3 to be executed by the processor 31. The storage device 32 further stores a database DB. The database D13 stores identification information, the transmission information, reception date and time information, and transmission date and time information in association with one another. The identification information is information for uniquely identifying the transmission information. The transmission information is received from one of the terminal apparatuses 10-1 to 10-J, which is a sender. The reception date and time information indicates date and time at which the server 30 received the transmission information. The transmission date and time information indicates transmission date and time at which the transmission information was transmitted to one of the terminal apparatuses 10-1 to 10-J, which is a recipient.

The communication device 33 is hardware that is a transmitting and receiving device configured to communicate with other devices. For example, the communication device 33 may be referred to as a network device, a network controller, a network card, a communication module, etc. The communication device 33 may include a connector for wired connection and an interface circuit corresponding to the connector for wired connection. The communication device 33 may include a wireless communication interface. The connector for wired connection and the interface circuit may conform to wired LAN, IEEE1394, or USB. The wireless communication interface may conform to wireless LAN or Bluetooth (registered trademark), etc.

The display 34 is a device for displaying images and text information. The display 34 displays various types of images under control of the processor 31. As the display 34, a type of display panel such as a liquid crystal display panel and an organic EL display panel is preferably used, for example.

The input device 35 is a device for receiving operations by a manager of the information processing system 1. For example, the input device 35 includes a pointing device such as a keyboard, a touch pad, a touch panel, or a mouse. In a case in which the input device 35 includes a touch panel, the input device 35 may also serve as the display 34.

The processor 31 reads the control program PR3 from the storage device 32 and executes the read control program RP3, for example. As a result, the processor 31 functions as an acquirer 311 and a provider 312.

The acquirer 311 acquires various types of information including the transmission information from the terminal apparatus 10-K via the communication device 33.

The provider 312 refers to the recipient information included in the transmission information and provides the transmission information to the recipient address indicated by the recipient information via the communication device 33.

### 1. 2: Operation of Embodiment

Operations of the terminal apparatus 10-K are divided into transmission processing and reception processing, which will be described.

### 1. 2. 1: Transmission Processing

FIG. 13 is a flowchart showing a transmission processing procedure executed by the terminal apparatus 10-K according to this embodiment.

At step S1, the processor 11 functions as the acquirer 111. The processor 11 acquires message information created by the user U[K].

At step S2, the processor 11 functions as the display controller 115 and the imagery generator 118. The processor 11 generates a virtual object VO corresponding to the message information created at step S1, and causes the pair of XR glasses 20-K to display the created virtual object VO. The user U[K] may perform the following operations, for example. First, the user U[K] preforms an operation of a gesture, an operation of a line of sight, or an operation of the input device 15 so as to enter an instruction to generate a virtual object VO for message. The processor 11 receives the operation described above and displays the virtual object VO in the virtual space VS. Second, the user U[K] performs an operation to drag and drop a virtual object representing a message such as text onto the virtual object VO for transmission. For example, in FIG. 14A, an operation to drag and drop a virtual object VOt representing “Hello!” onto the virtual object VO for transmission causes message information corresponding to “Hello!” and the virtual object VO to be associated with each other.

At step S3, the processor 11 functions as the display controller 115 and the receiver 112. The processor 11 determines whether an operation to move the virtual object VO at a recipient apparatus is received. For example, the processor 11 causes the pair of XR glasses 20-K to display a virtual space VS shown in FIG. 14B. In this case, a button B1 and a button B2 are displayed in conjunction with a message “Do you want to generate a movement track for the virtual object?” in association with the virtual object VO. The button B1 is used by the user U[K] to enter an instruction to move the virtual object VO at the recipient apparatus. The button B2 is used by the user U[K] to enter an instruction not to move the virtual object VO at the recipient apparatus. When the user U[K] operates the button B1, the processor 11 determines that an operation to move the virtual object VO at the recipient apparatus is received. On the other hand, when the user U[K] operates the button B32, the processor 11 determines that an operation not to move the virtual object VO at the recipient apparatus is received.

When the determination at step S3 is negative, the processor 11 advances the processing to step S5. On the other hand, when the determination at step S3 is affirmative, the processor 11 generates movement track information (step S4).

FIG. 15 is a flowchart showing a detailed operation of the terminal apparatus 10-K to generate the movement track information. At step S41, the processor 11 functions as the display controller 115 and the receiver 112. The processor 11 determines whether input of a user movement track is received. For example, the processor 11 causes the pair of XR glasses 20-K to display a virtual space VS shown in FIG. 16A. In this case, a button B3 and a button 14 are displayed in conjunction with a message “Do you want to move the virtual object?” in association with the virtual object VO. The button B3 is used by the user U[K] to enter an instruction that the user U[K] will move the virtual object VO. The button B4 is used by the user U[K] to enter an instruction that the user U[K] will not move the virtual object VO. When the user U[K] operates the button B3, the processor 11 determines that input of a user movement track is received. On the other hand, when the user U[K] operates the button B4, the processor 11 determines that input of a user movement track is not received.

If the determination at step S41 is affirmative, the processor 11 advances the processing to step S42. At step S42, the processor 11 functions as the user movement track generator 113A. When the user U[K] holds the virtual object VO in one hand and moves the virtual object VO in the virtual space VS, the processor 11 determines a movement track of the virtual object VO by tracking locations of the hand of the user U[K]. The processor 11 generates user movement track information indicative of the determined movement track.

At step S43, the processor 11 functions as the display controller 115 and the receiver 112. The processor 11 determines whether an instruction to combine movement tracks is received. For example, the processor 11 causes the pair of XR glasses 20-K to display a virtual space VS shown in FIG. 16B. In this case, a button B5 and a button B6 are displayed in conjunction with a message “Do you want to combine movement tracks?” in association with the virtual object VO. The button B5 is used by the user U[K] to enter an instruction to combine movement tracks. The button 16 is used by the user U[K] to enter an instruction not to combine movement tracks. When the user U[K] operates the button 115, the processor 11 determines that the instruction to combine movement tracks is received. On the other hand, when the user U[K] operates the button B6, the processor 11 determines that the instruction to combine movement tracks is not received.

When the determination at step 943 is negative, the processor 11 advances the processing to step S46. When the determination at step S43 is affirmative, the processor 11 advances the processing to step S44.

At step S44, the processor 11 functions as the reference movement track selector 113B, the display controller 115, and the receiver 112. For example, the processor 11 causes the pair of XR glasses 20-K to display a virtual space VS shown in FIG. 11B. This display prompts the user U[K] to select one or more reference movement tracks from among the plurality of reference movement tracks. The processor 11 receives one or more reference movement tracks selected by the user U[K].

At step S45, the processor 11 functions as the track combiner 113C. The processor 11 generates a combined movement track based on reference movement track information corresponding to the one or more movement tracks received at step S44 and on the user movement track information generated at step S42.

At step S46, the processor 11 functions as the movement track information generator 113. The processor 11 generates movement track information indicative of the movement track of the virtual object VO that is moved in the virtual space VS.

When it is determined at step S41 that input of a user movement track is not received, the processor 11 advances the processing to step S47. At step S47, the processor 11 receives one or more reference movement tracks selected by the user U[K], as at step S44.

At step S48, the processor 11 determines whether two or more reference movement tracks are selected by the user U[K].

When the determination at step S48 is affirmative, the processor 11 advances the processing to step S45. In this case, the processor 11 combines the two or more reference movement tracks selected by the user U[K].

On the other hand, when the determination at step S48 is negative, the processor 11 advances the processing to step S46. In this case, the processor 11 generates movement track information indicative of the reference movement track selected by the user U[K]. The above description is detailed processing at step S4 shown in FIG. 13.

At step S5 shown in FIG. 13, the processor 11 functions as the receiver 112. The processor 11 receives a recipient specified by the user U[K]. Through this reception, the processor 11 acquires the recipient information.

At step S6, the processor 11 generates transmission information. Specifically, the processor 11 generates the transmission information that includes the message information generated at step S1, the movement track information acquired at step S4, the recipient information acquired at step S5, and sender information.

At step S7, the processor 11 functions as the transmission controller 116. The processor 11 causes the communication device 13 to transmit the transmission information to the recipient.

### 1. 2. 2: Reception Processing

FIG. 17 is a flowchart showing a reception processing procedure executed by the terminal apparatus 10-K according to this embodiment.

At step S11, the processor 11 functions as the reception controller 117. The processor 11 acquires transmission information by causing the communication device 13 to receive the transmission information.

At step S12, the processor 11 functions as the reception controller 117. The processor 11 determines whether the transmission information includes movement track information. When the determination at step S12 is negative, the processor 11 ends the reception processing.

When the determination at step S12 is affirmative, the processor 11 functions as the imagery generator 118 at step S13. Based on the movement track information included in the transmission information, the processor 11 generates external image information representing imagery in which the virtual object VO moves in the virtual space VS.

At step S14, the processor 11 functions as the display controller 115. The processor 11 provides the external image information generated at step S13 to the pair of XR glasses 20-K via the communication device 13. This output allows the pair of XR glasses 20-K to display the virtual space VS in which the virtual object VO moves.

### 1. 3: Effect of Embodiment

According to the above description, the terminal apparatus 10-K that serves as the message transmitting apparatus includes the movement track information generator 113, the transmission information generator 114, and the transmission controller 116. When the virtual object VO corresponding to a message is moved in the virtual space VS in accordance with an operation by the user U[K] who is the sender, the movement track information generator 113 generates movement track information on a movement track of the virtual object VO. The transmission information generator 114 generates transmission information including the movement track information and message information indicative of the message. The transmission controller 116 causes the communication device 13 to transmit the transmission information to a recipient specified by the user U[K].

The terminal apparatus 10-K transmits the transmission information, which includes the message information and the movement track information on the movement track of the virtual object VO, to the recipient; thus, a recipient apparatus can play, based on the movement track information, movement of the virtual object VO moved in accordance with the operation by the user U[K] who is the sender. Therefore, the user U[K] who is the sender of the message can control movement of the virtual object VO in the virtual space visually recognized by a user who is a recipient of the message.

According to the above explanation, the movement track represents a change in a location of the virtual object VO in the virtual space VS over time. The movement track information generator 113 generates the movement track information by executing processing on the movement track, the processing being processing to remove a noise component caused by the operation by the user U[K].

When the user U[K] touches the virtual object VO in the virtual space VS to move the virtual object VO, a swing of a hand of the user U[K] may be reflected in the movement track of the virtual object VO. The terminal apparatus 10-K executes the processing to remove a noise component, thereby removing a component caused by the swing of a hand of the user U[K], which is to be reflected in the movement track. Thus, movement of the virtual object VO in the virtual space visually recognized by the user who is the recipient can be made smooth.

According to the above explanation, the operation by the user U[K] who is the sender includes a first operation in which the user U[K] who is the sender selects, as one or more movement tracks of the virtual object VO, one or more movement tracks from among the plurality of movement tracks prepared in advance, and a second operation in which the user U[K] who is the sender moves the virtual object VO in the virtual space VS. The movement track information generator 113 generates, as the movement track information, information indicative of a movement track obtained by combining the one or more movement tracks selected in the first operation with a movement track of the virtual object specified in the second operation.

Since the terminal apparatus 10-K includes the above-described configuration, it is possible to add effects to the movement track of the virtual object specified in the second operation. Since the user U[K] who is the sender selects one or more movement tracks from among the plurality of movement tracks, it is possible to generate a variety of movement tracks of the virtual object.

According to the above explanation, the terminal apparatus 10-K that serves as the message receiving apparatus includes the reception controller 117 configured to cause the communication device 13 to receive the transmission information transmitted by a message transmitting apparatus, the imagery generator 118 configured to generate imagery in which the virtual object VO moves in the virtual space VS in accordance with the movement track information included in the transmission information, and the display controller 115 configured to cause the pair of XR glasses 20-K for the user U[K] who is the recipient to display the generated imagery.

Since the terminal apparatus 10-K includes the above-described configuration, it is possible to reproduce a movement track of the virtual object, which is moved by a user who is a sender in a virtual space, in a virtual space VS visually recognized by the user U[K] who is the recipient.

### 3: Modifications

This disclosure is not limited to the embodiment described above. Specific modifications will be explained below. Two or more modifications freely selected from the following modifications may be combined.

### 3. 1: First Modification

In the information processing system 1 according to this embodiment, the terminal apparatus 10-K includes the acquirer 111, the receiver 112, and the movement track information generator 113. However, instead of the terminal apparatus 10-K, the servers 30 may include elements that are substantially the same as the elements described above. Similarly, instead of the terminal apparatus 10-K, the servers 30 may include elements that are substantially the same as other elements. When the server 30 includes the acquirer 111, the receiver 112, and the movement track information generator 113, various types of information acquired by the terminal apparatus 10-K from the pair of XR glasses 20-K are transmitted by the terminal apparatus 10-K to the server 20. The operation information provided by the input device 15 of the terminal apparatus 10-K is also transmitted to the server 30.

### 3.2: Second Modification

In the information processing system 1 according to this embodiment, the terminal apparatus 10-K and the pair of XR glasses 20-K are implemented to be separate from each other. However, a way to implement the terminal apparatus 10-K and the pair of XR glasses 20-K according to this embodiment of the present invention is not limited thereto. For example, the pair of XR glasses 20-K may include functions that are the same as those of the terminal apparatus 10-K. In other words, the terminal apparatus 10-K and the pair of XR glasses 20-K may be implemented in a single housing.

### 3. 3: Third Modification

in the terminal apparatus 10-K according to this embodiment, after the message information is generated, the virtual object VO corresponding to the message is generated. However, first, the user U[K] uses the input device 15 to generate a virtual object VO, and then message information that is associated with the virtual object VO may be created.

### 3.4: Fourth Modification

The information processing system 1 according to this embodiment includes the pair of XR glasses 20-K. However, the information processing system 1 may include, instead of the pair of XR glasses 20-K, any one of a pair of VR glasses in which a VR technique is adopted, a head mounted display (HMD) in which a VR technique is adopted, a pair of AR glasses in which an AR technique is adopted, and an HMD in which an AR technique is adopted. Alternatively, the information processing system 1 may include, instead of the pair of XR glasses 20-K, any one of an ordinary smartphone and a tablet provided with a capturing device. The pair of VR glasses, the pair of AR glasses, the HMD, the smartphone, and the tablet are each an example of a display.

### 4: Other Matters

(1) In the foregoing embodiment, the storage device 12, the storage device 22, and the storage device 32 are each, for example, a ROM and a RAM; however, the storage devices may include flexible disks, magneto-optical disks (e.g., compact disks, digital multi-purpose disks. Blu-ray (registered trademark) discs, smart-cards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. The program may be transmitted by a network via telecommunication lines. Alternatively, the program may be transmitted by a communication network NET via telecommunication lines.

(2) In the foregoing embodiment, information, signals, etc., may be presented by use of various techniques. For example, data, instructions, commands, information, signals, bits, symbols, chips, etc., may be presented by freely selected combination of voltages, currents, electromagnetic waves, magnetic fields or magnetic particles, light fields or photons.

(3) in the foregoing embodiment, the input and output of information, or the input or the output of information, etc., may be stored in a specific location (e.g., memory) or may be managed by use of a management table. The information, etc., that is, the input and output, or the input or the output, may be overwritten, updated, or appended. The information, etc., that is output may be deleted. The information, etc., that is input may be transmitted to other devices.

(4) In the foregoing embodiment, determination may be made based on values that can be represented by one bit (0 or 1), may be made based on Boolean values (true or false), or may be made based on comparing numerical values (for example, comparison with a predetermined value).

(5) The order of processes, sequences, flowcharts, etc., that have been used to describe the foregoing embodiment may be changed as long as they do not conflict. For example, although a variety of methods has been illustrated in this disclosure with a variety of elements of steps in exemplary orders, the specific orders presented herein are by no means limiting.

(6) Each function shown in FIG. 1 to FIG. 17 is implemented by any combination of hardware and software. The method for realizing each functional block is not limited thereto. That is, each functional block may be implemented by one device that is physically or logically aggregated. Alternatively, each functional block may be realized by directly or indirectly connecting two or more physically and logically separate, or physically or logically separate, devices (by using cables and radio, or cables, or radio, for example), and using these devices. The functional block may be realized by combining the software with one device described above or two or more of these devices.

(7) The programs shown in the foregoing embodiment should be widely interpreted as an instruction, an instruction set, a code, a code segment, a program code, a subprogram, a software module, an application, a software application, a software package, a routine, a subroutine, an object, an executable file, an execution thread, a procedure, a function, or the like, regardless of whether it is called software, firmware, middleware, microcode, hardware description language, or other names.

Software, instructions, etc., may be transmitted and received via communication media. For example, when software is transmitted by a website, a server, or other remote sources, by using wired technologies such as coaxial cables, optical fiber cables, twisted-pair cables, and digital subscriber lines (DSL), and wireless technologies such as infrared radiation and radio and microwaves by using wired technologies, or by wireless technologies, these wired technologies and wireless technologies, wired technologies, or wireless technologies, are also included in the definition of communication media.

(8) In each aspect, the terms “system” and “network” are used interchangeably.

(9) The information and parameters described in this disclosure may be represented by absolute values, may be represented by relative values with respect to predetermined values, or may be represented by using other pieces of applicable information.

(10) in the foregoing embodiment, the terminal apparatuses 10-1 to 10-4 and the server 30 may each be a mobile station (MS). A mobile station may be referred to, by one skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms. The terms “mobile station”, “user terminal”, “user equipment (UE)”, “terminal”, etc., may be used interchangeably in the present disclosure.

(11) in the foregoing embodiment, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination thereof. For example. “connection” may be replaced with “access.” As used in this specification, two elements may be considered “connected” or “coupled” to each other by using one or more electrical wires, cables, and printed electrical connections, or by using one or more electrical wires, cables, or printed electrical connections. In addition, two elements may be considered “connected” or “coupled” to each other by using electromagnetic energy, etc., which is a non-limiting and non-inclusive example, having wavelengths in radio frequency regions, microwave regions, and optical (both visible and invisible) regions.

(12) In the foregoing embodiment, the phrase “based on” as used in this specification does not mean “based only on”, unless specified otherwise. In other words, the phrase “based on” means both “based only on” and “based at least on.”

(13) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining, etc., has taken place. Furthermore, “determining” may be used when practically “determining” that some act of receiving (for example, receiving information), transmitting (for example, transmitting information), inputting, outputting, accessing (for example, accessing data in a memory) etc., has taken place. Furthermore, “determining” may be used when practically “determining” that some act of resolving, selecting, choosing, establishing, comparing, etc., has taken place. That is, “determining” may be used when practically determining to take some action. The term “determining” may be replaced with “assuming”, “expecting”, “considering”, etc.

(14) As long as terms such as “include”, “including” and modifications thereof are used in the foregoing embodiment, these terms are intended to be inclusive, in a manner similar to the way the term “comprising” is used. In addition, the term “or” used in the specification or in claims is not intended to be an exclusive OR.

(15) In the present disclosure, for example, when articles such as “a”. “an”, and “the” in English are added in translation, these articles include plurals unless otherwise clearly indicated by the context.

(16) in this disclosure, the phrase “A and B are different” may mean “A and B are different from each other.” The phrase “A and B are different from C, respectively” may mean that “A and B are different from C”. Terms such as “separated” and “combined” may be interpreted in the same way as “different.”

(17) The examples and embodiments illustrated in this specification may be used individually or in combination, which may be altered depending on the mode of implementation. A predetermined piece of information (for example, a report to the effect that something is “X”) does not necessarily have to be indicated explicitly, and may be indicated in an implicit way (for example, by not reporting this predetermined piece of information, by reporting another piece of information, etc.).

Although this disclosure is described in detail, it is obvious to those skilled in the art that the present invention is not limited to this embodiment described in the specification. This disclosure can be implemented with a variety of changes and in a variety of modifications, without departing from the spirit and scope of the present invention as defined in the recitations of the claims. Consequently, the description in this specification is provided only for the purpose of explaining examples and should by no means be construed to limit the present invention in any way.

### DESCRIPTION OF REFERENCE SIGNS

1 . . . information processing system, 10-1, 10-2, 10-K, 10-3 . . . terminal apparatus, 11 . . . processor. 12 . . . storage device, 13 . . . communication device. 14 . . . display, 15 . . . input device, 16 . . . inertial sensor, 20-1, 20-2, 20-K, 20-J . . . a pair of XR glasses, 21, processor, 23 . . . line-of-sight detector, 26 . . . capturing device, 27 . . . communication device, 29L, 29R . . . depth detector, 30 . . . server, 31 . . . processor. 32 . . . storage device, 33 . . . communication device, 11 . . . acquirer, 112 . . . receiver, 113 . . . movement track information generator, 114 . . . transmission information generator, 115 . . . display controller, 116 . . . transmission controller, 117 . . . reception controller, 118 . . . imagery generator. U[K] . . . user, VO . . . virtual object.

1. A message transmitting apparatus comprising:
a movement track information generator configured to, when a virtual object corresponding to a message is moved in a virtual space in accordance with an operation by a user who is a sender, generate movement track information on a movement track of the virtual object;
a transmission information generator configured to generate transmission information including:
the movement track information; and
message information indicative of the message; and
a transmission contoller configured to cause a communication device to transmit the transmission information to a recipient specified by the user.

2. The message transmitting apparatus according to claim 1,
wherein the movement track represents a change in a location of the virtual object in the virtual space over time, and
wherein the movement track information generator is configured to generate the movement track information by executing processing on the movement track, the processing being processing to remove a noise component caused by the operation by the user.

3. The message transmitting apparatus according to claim 1,
wherein the operation by the user who is the sender includes:
a first operation in which the user who is the sender selects, as one or more movement tracks of the virtual object, one or more movement tracks from among a plurality of movement tracks prepared in advance; and
a second operation in which the user who is the sender moves the virtual object in the virtual space, and
wherein the movement track information generator is configured to generate, as the movement track information, information indicative of a movement track obtained by combining the one or more movement tracks selected in the first operation with a movement track of the virtual object specified in the second operation.

4. A message receiving apparatus comprising:
a reception controller configured to cause a communication device to receive the transmission information transmitted by the message transmitting apparatus according to any one of claims 1 to 3;
an imagery generator configured to generate imagery in which a virtual object moves in a virtual space in accordance with the movement track information included in the transmission information; and
a display controller configured to cause a display for a user who is the recipient to display the generated imagery.
